(19) United States
(12) Patent Application Publication
(10) Pub. No.: US 2008/0093437 A1
(43) Pub. Date: Apr. 24, 2008

(54) Automated teller machine

(75) Inventor: James Henderson, St. Andrews (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/585,642

(22) Filed: Oct. 24, 2006

(51) Int. Cl. G07F 19/00; G06F 7/08

(52) U.S. Cl. 235/379; 235/381

(57) ABSTRACT

An ATM comprises a) an ATM head unit in the form of a housing within which are housed user interface components of an ATM; and b) a security enclosure within which is located an ATM media dispenser. The security enclosure and the head unit are discrete physically separate units, which are coupled so that media from the security enclosure can be dispensed to a user through interaction with the head unit, when in use.

### BACKGROUND OF THE INVENTION

The present invention relates to an Automated Teller Machine (ATM).

There are a number of issues with current ATM designs including product packaging, cost points, and product variants. By providing one low cost assembly for through-the-wall, in-lobby, and free standing ATMs this invention addresses those issues.

In addition, the invention looks at a revolutionary re-think of the way in which a user interface of an ATM is presented to users. In the past an ATM has taken up a significant floor area of a financial institution or outdoor space. Also, in through-the-wall ATMs there has been a need for significant building work including cutting a hole in a wall of approximately the dimensions of the present user interface. This increases ATM implementation costs and times.

### SUMMARY OF THE INVENTION

It is an object of the present invention to provide an ATM which addresses as least some of the problems detailed above.

In accordance with one aspect of the present invention there is provided an automated teller machine (ATM) comprising: an ATM head unit in the form of a housing within which are housed user interface components of an ATM; a security enclosure within which is located an ATM media dispenser; wherein the security enclosure and the head unit are discrete physically separate units, which are coupled so that media from the security enclosure can be dispensed to a user through interaction with the head unit, when in use.

Preferably, the media dispenser is a cash dispenser.

In one embodiment the security enclosure further contains a media acceptor.

Preferably the user interface components include a card reader, a key pad, a cash dispenser slot, a display with FDKs, and a receipt printer. However, according to the embodiment the head unit may not contain all of these components.

Preferably, the head unit is arranged to operate at low voltage, most preferably 24V.

In one embodiment the ATM is a through-the-wall ATM, wherein the head unit is arranged to be hung on one side of a wall, in use, and the security enclosure is arranged to be located on the opposite side of the wall, the units being coupled by a cash transit path through an aperture in the wall. Preferably, the ATM is arranged to be front opening for repair or replenishment.

Preferably, the ATM includes means for wireless communication between the head unit and the security enclosure.

According to a second aspect of the present invention there is provided an automated teller machine (ATM) comprising: an ATM head unit in the form of a housing within which are housed user interface components of an ATM, including; a card reader, a key pad, a cash dispenser slot, a display with FDKs, and a receipt printer; a security enclosure within which is located an ATM media dispenser; wherein the security enclosure and the head unit are discrete physically separate units, which are coupled so that media from the security enclosure can be dispensed to a user through interaction with the head unit, when in use.

The above and other objects, features, and advantages of the present invention will become apparent from the following description and the attached drawings

### BRIEF DESCRIPTION OF THE DRAWINGS

FIG. 1 is a perspective view of a head unit of an ATM in accordance with an embodiment of the preset invention;

FIG. 2 is a block diagram representation of the head unit of FIG. 1;

FIG. 3 is perspective diagram of an ATM in accordance with an embodiment of the present invention arranged with the head and security enclosures on opposite sides of a wall.

### DETAILS OF THE INVENTION

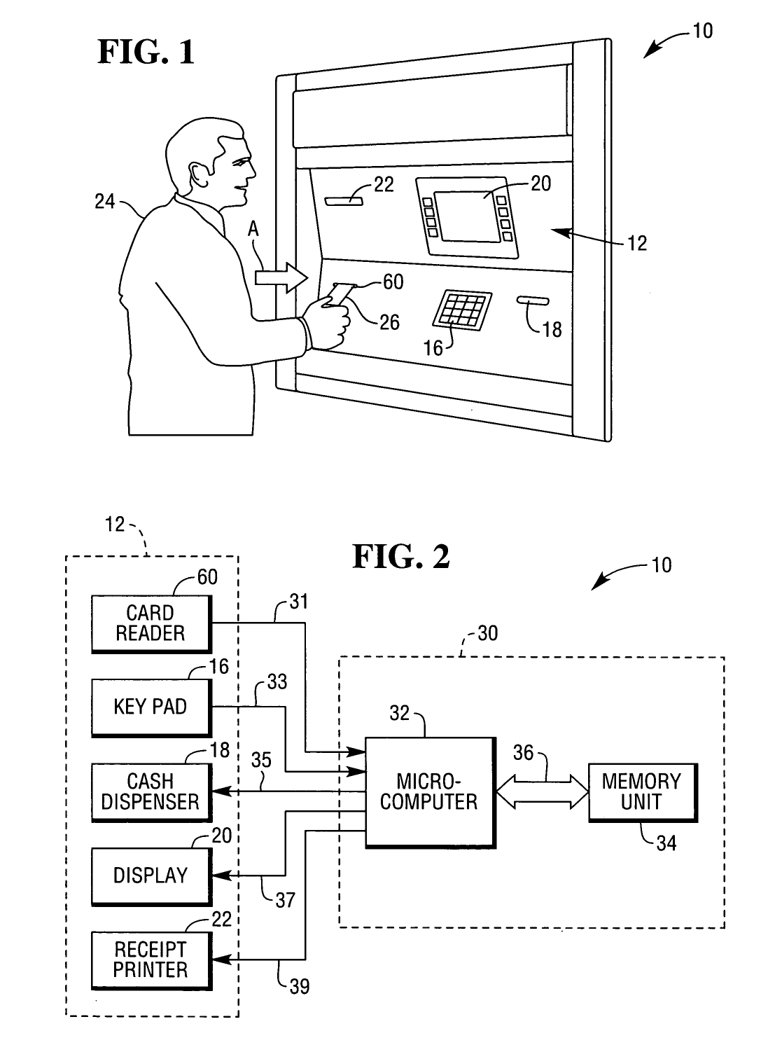

The present invention is directed to an ATM. The specific construction of the ATM may vary. An ATM head unit 10 embodying the present invention is illustrated in FIGS. 1 and 2.

The ATM includes a head unit 10 comprises a user interface in the form of a front panel 12. The front panel 12 includes a card reader 60, a key pad 16, a cash dispenser slot 18, a display 20, and a receipt printer 22. As particularly shown in FIG. 1, the card reader 60 has a card entry slot through which a customer 24 can insert a user identification card 26 at the commencement of a transaction to be conducted by the customer. The cash dispenser has a cash slot 18 through which cash currency notes stored inside the security enclosure of the ATM can be delivered to the customer 24 during the transaction. The receipt printer 22 has a receipt slot through which a receipt of the transaction is delivered to the customer 24 at termination of the transaction.

When the customer 24 inserts the user identification card 26 into the card entry slot of the card reader 60, the card reader reads data contained on the card. The customer 24 is then prompted on the display 20 to enter a personal identification number (PIN) via the key pad 16. After the correct PIN is entered, menus are displayed on the display 20 to enable the customer 24 to carry out the desired transaction. After the transaction is completed, the receipt printer 22 prints a receipt of the transaction and delivers the receipt through the slot of the receipt printer 22 to the customer 24.

Referring particularly to FIG. 2, the ATM 10 further comprises a controller unit 30 which communicates with components of the front panel 12. The controller unit 30 includes a microcomputer 32 and a memory 34 connected via bus line 36 to the microcomputer 32. The microcomputer 32 receives input signals on lines 31, 33 from the card reader 60 and the key pad 16, respectively, and provides output signals on lines 35, 37, 39 to the cash dispenser 18, the display 20, and the receipt printer 22, respectively, to control the amount of cash dispensed by the cash dispensed by the cash dispenser 18, the information displayed on the display 20, and the information printed by the receipt printer 22. The memory 34 may be non-volatile RAM. Suitable microcomputers and memories are readily available in the marketplace. Their structure and operation are well known and, therefore, will not be described.

The microcomputer 32 communicates via a line with a central terminal located remotely from the ATM. Preferably, the line is a proprietary network owned by the financial institution which operates the ATM. The remote central terminal may be located at the headquarters of the financial institution.

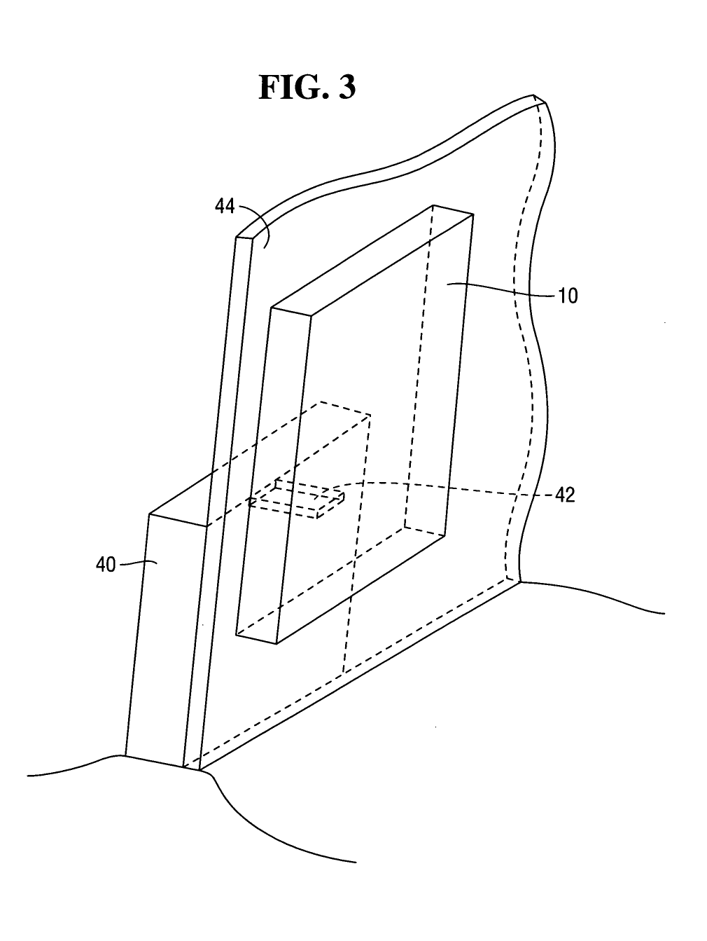

FIG. 3 illustrates a through-the-wall ATM in accordance with the present invention in place and ready for use.

The ATM comprises a head unit 40 in the form of a housing within which are housed user interface components of an ATM. These component include all of the components necessary to operate an ATM including a card reader, a key pad, a cash dispenser slot, a display with FDKs, and a receipt printer. The ATM further includes a security enclosure 42 within which is located an ATM media dispenser. The dispenser is a standard dispenser in which the transport path is arranged to provide picked notes to the user through the head unit 10. This is achieved by providing a small aperture 42 from the security enclosure 40 to the dispenser slot 18 of the head unit 10.

The units 10, 40 are discrete physically separate units, which are coupled as detailed above.

The ATM can be arranged to dispense media other than cash, such as travel tickets and the like.

In addition the ATM can be arranged to accept media if the security enclosure further contains a media acceptor.

The ATM head unit 10 is arranged to operate at low voltage normally 24V.

The ATM can be a lobby ATM, a drive through ATM or a through-the-wall ATM. In the latter case the head unit 10 is arranged to be hung on one side of a wall 44, in use, and the security enclosure 40 is arranged to be located on the opposite side of the wall 44, as illustrated in FIG. 3. Communication between the units 10, 40 is achieved because the units 10, 40 include means for wireless communication. The units can be linked via wires if required.

The ATM head unit 10 is arranged to be front opening for repair or replenishment.

From the above description of the invention, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

1. An automated teller machine (ATM) comprising:
a. an ATM head unit in the form of a housing within which are housed user interface components of an ATM;
b. a security enclosure within which is located an ATM media dispenser in which the security enclosure and the head unit
i) are discrete physically separate units,
ii) located in different rooms of a building,
iii) are coupled so that media from the security enclosure can be dispensed to a user through interaction with the head unit, when in use.

2. An ATM according to claim 1, wherein the media dispenser is a cash dispenser.

3. An ATM according to claim 1, wherein the security enclosure further contains a media acceptor.

4. An ATM according to claim 1, wherein the user interface components include a card reader, a key pad, a cash dispenser slot, a display with FDKs, and a receipt printer.

5.-6. (canceled)

7. An ATM according to claim 1, which comprises a through-the-wall ATM.

8. An ATM according to claim 7, wherein the head unit is arranged to be hung on one side of a wall of a building, in use, and the security enclosure is arranged to be located on the opposite side of the wall, the units being coupled by a cash transit path through an aperture in the wall.

9. An ATM according to claim 1, which is arranged to be front opening for repair or replenishment.

10. An ATM according to claim 1, including means for two-way wireless communication between the head unit and the security enclosure.

11. An automated teller machine (ATM) comprising:
a. an ATM head unit in the form of a housing within which are housed user interface components of an ATM, including: a card reader, a key pad, a cash dispenser slot, a display with FDKs, and a receipt printer;
b. a security enclosure within which is located an ATM media dispenser; wherein the security enclosure and the head unit are discrete physically separate units, locatable in different rooms when the ATM is operative, which are coupled so that media from the security enclosure can be dispensed to a user through interaction with the head unit, when in use.

12. An ATM according to claim 1, wherein the media dispenser is a cash dispenser.

13. An ATM according to claim 1, wherein the security enclosure further contains a media acceptor.

14. A system, comprising:
a) a wall of a building;
b) an automated teller machine (ATM), which is divided into two components, including:
i) an interface, located on one side of the wall, which comprises
A) a display and a keypad with which a customer interacts; and
B) a slot through which cash is dispensed to the customer;
ii) a cash dispenser, located on the other side of the wall; and
c) an aperture in the wall, through which the cash dispenser transmits cash to the slot.

15. An ATM according to claim 10, in which the communication occurs during every transaction.

16. An ATM according to claim 15, in which the communication carries input from a customer to components within the security enclosure.

17. An ATM according to claim 14, in which the wall separates the interface from the cash dispenser at substantially all locations, with the exception of the aperture.
